(19) United States
(12) Patent Application Publication
(10) Pub. No.: US 2007/0199418 A1
(43) Pub. Date: Aug. 30, 2007

(54) Instrument for fabricating prepared slide of tissue section and sectioning method

(76) Inventor: Tetsumasa Ito, Chiba-shi (JP)

Correspondence Address: BRINKS HOFER GILSON & LIONE, P.O. BOX 10395, CHICAGO, IL, 60610, US

(21) Appl. No.: 11/703,484

(22) Filed: Feb. 7, 2007

(30) Foreign Application Priority Data
Feb. 13, 2006 (JP) JP2006-035054

(51) Int. Cl. B26D 1/00; B26D 7/00

(52) U.S. Cl. 83/13; 83/520; 83/915.5

(57) ABSTRACT

To provide an instrument for fabricating a prepared slide of a tissue section and a sectioning method capable of easily changing a direction of a cut face relative to a cut blade while observing the cut face of an embedding block and capable of increasing an efficiency of a rough cutting operation by specifying a section face by an inconsiderable burden regardless of skill of an operator, an instrument for fabricating a prepared slide of a tissue section includes a cut blade moving along one imaginary plane, a collimated on axis illuminating system having an optical axis in parallel with Z axis orthogonal to the one imaginary plane, an observing system having an image taking portion arranged with an image taking element, not illustrated, having an image taking axis the same as the optical axis and a display portion for displaying an image based on an image taking data acquired by the image taking portion, a base portion including a support base (support portion) for mounting an embedding block, a pivoting mechanism for pivoting the support base around respective axes of X, Y axes, and a straight advancing mechanism for moving the support base in a direction of Z axis, and a joy stick (pivoting operating portion) for operating the pivoting mechanism.

This application claims priority under 35 U.S.C. §119 to Japanese Patent Application No. JP 2006-035054 filed Feb. 13, 2006, the entire content of which is hereby incorporated by reference.

### BACKGROUND OF THE INVENTION

1. Field of the Invention

The present invention relates to an instrument for fabricating a prepared slide of a tissue section and a sectioning method used in fabricating a prepared slide used in scientific experiments or microscopic observation.

2. Description of the Related Arts

In pathologic diagnosis, there is carried out pathologic inspection for observing a tissue of an animal or a person affected with a disease which is sectioned to a thickness of 2 μm through 5 μm and is stained variously by a microscope in order to carry out a diagnosis based on a knowledge base obtained in the past. At this occasion, since pathology is constituted by enormous knowledge with regard to disease and a morphological change in tissue, in order to utilize the past knowledge, it is necessary to fabricate a prepared slide such that a tissue necessary for the diagnosis emerges by cutting a sample subjected to observation by a specific section.

At this occasion, in order to section a soft tissue or a cell such that a form thereof is not destructed, it is generally carried out to embed the sample in paraffin to constitute an embedding block. In fabricating the sample subjected to observation from the embedding block, first, the embedding block is roughly cut to make a surface thereof smooth, and the embedded sample constituting an object of experiment or observation is exposed to the surface. Further, in regular cutting, the embedding block is sliced to be extremely thin by a cut blade.

However, paraffin is crystallized to be turbid in white when solidified, and therefore, a three-dimensional form of the embedded sample cannot be observed from outside. Hence, in a related art, in rough cutting, an operator successively slices from a top face of the embedding block to expose a requested section face by adjusting a cutting amount or an angle of a base mounted with the embedding block while observing a face of the sample surfaced from paraffin. Therefore, the operation cannot be carried out over again, further, cutting needs to be repeated by several tens times until surfacing a desired section face, which needs skill and attentive power over a long period of time.

Here, there is proposed an instrument for fabricating a prepared slide of a tissue section used in carrying out a rough cutting step which is provided with an observing apparatus (refer, for example, to JP-A-06-265452). According to the apparatus, imaging or spectroscopic analysis of a cut face is carried out while cutting the embedding block, and a result thereof can be stored. On the other hand, in order to illuminate a sample, there is also proposed an instrument including an up emitting light illuminating apparatus, a down emitting light illuminating apparatus, a sample inside illuminating apparatus having LED (light-emitting diode) (refer, for example, to JP-A-2004-37459).

However, in a case of the instrument for fabricating a prepared slide of a tissue section described in JP-A-06-265452, a consideration is not given to a control for determining the section face which is indispensable for fabricating the prepared slide. Further, when a tissue is nearly transparent, or when a tissue is small, an identifiable image cannot be provided. Further, in a case of the instrument for fabricating a prepared slide of a tissue section described in JP-A-2004-37459, when it is necessary to change a direction of cutting the embedding block by the cut blade as a result of observation of the cut face, skill is still required for an adjusting operation and a burden on the operator is considerable.

### SUMMARY OF THE INVENTION

The invention has been carried out in view of the above-described situation and it is an object thereof to provide an instrument for fabricating a prepared slide of a tissue section and a sectioning method capable of easily changing a direction of a cut face relative to a cut blade while observing the cut face of an embedding block and capable of increasing an efficiency of a rough cutting operation by specifying a section face with an inconsiderable burden regardless of skill of an operator.

The invention adopts the following means in order to resolve the above-described problem.

According to the invention, there is provided an instrument for fabricating a prepared slide of a tissue section comprising a cut blade moved along one imaginary plane, a collimated on axis illuminating system having an optical axis orthogonal to the one imaginary plane, an observing system including an image taking portion having an image taking axis substantially the same as the optical axis and a display portion for displaying an image based on an image taking data acquired by the image taking portion, and a base portion including a support portion mounted with an embedding block in which a sample is embedded in an embedding medium, a pivoting mechanism for pivoting the support portion around respective axes of two axes orthogonal to each other on the one imaginary plane, and a straight advancing mechanism for moving the support portion in a direction orthogonal to the one imaginary plane and arranged on the optical axis.

According to the invention, the image provided by taking the image of a cut face of the embedding block illuminated by the collimated on axis illuminating system can be displayed at the display portion. At this occasion, since illumination is down emitting illumination, based on a difference of reflectances of the sample and the embedding medium at inside of the embedding block, the operator can easily grasp a current state of cutting the embedding block. Further, when the embedding block needs to be cut by being inclined to the one imaginary plane, the embedding block can be cut by a desired inclined face by pivoting the support base.

Further, according to the instrument for fabricating a prepared slide of a tissue section of the invention, there is provided the instrument for fabricating a prepared slide of a tissue section, wherein a pivoting operating portion for operating the pivoting mechanism is provided at a position of being remote from the support portion. According to the invention, by arranging the pivoting operating portion to a side of the hands of the operator, an operation of inclining the support base relative to the cut blade at hand can be carried out while observing the image of the display portion, and a burden for adjustment can be alleviated.

Further, according to the instrument for fabricating a prepared slide of a tissue section of the invention, there is provided the instrument for fabricating a prepared slide of a tissue section, further comprising a diverging illuminating system having a light source for irradiating diverged light, and an illumination switching portion for bringing either one of the diverging illuminating system and the collimated on axis illuminating system into a drive state, wherein the observing system comprises a first image storing portion for storing an image data provided under illumination by the diverging illuminating system, and a second image storing portion for storing an image data provided under illumination by the collimated on axis illuminating system.

According to the invention, by the diverging illuminating system, not only the cut face of the sample but also a state thereof in a depth direction can be observed. Further, by respectively calling the image data stored to the first image storing portion and the second image storing portion, the image provided by either one of the diverging illuminating system or the collimated on axis illuminating system, and the image provided by other thereof can be displayed in a display portion simultaneously or respectively alternately and the cut face can further easily be specified.

Further, according to the instrument for fabricating a prepared slide of a tissue section of the invention, there is provided the instrument for fabricating a prepared slide of a tissue section, wherein a plurality of the base portions are arranged to align movably to be opposedly to a direction of moving the cut blade. According to the invention, the base portions can successively be moved to the observing system under the optical axis and the image taking axis, and the plurality of embedding blocks can continuously be cut roughly.

Further, according to the invention, there is provided a sectioning method which is a sectioning method comprising a rough cutting step of roughly cutting an embedding block in which a living body sample is embedded in an embedding medium by a cut blade, and a regular cutting step for providing a section from the embedding block after having been cut roughly, wherein the rough cutting step comprises an adjusting step of determining a position of a surface of the embedding block relative to the cut blade, a cutting step of cutting the surface of the embedding block by moving the cut blade along one imaginary plane, an illuminating step of illuminating a cut face of the embedding block from a direction orthogonal to the one imaginary plane, an observing step of taking an image of the cut face of the illuminated embedding block and displaying the image, and an evaluating step of determining whether the rough cutting step is to proceed to the regular cutting step from the image, wherein the rough cutting step returns to the adjusting step when proceeding to the regular cutting step is unacceptable at the evaluating step.

According to the invention, by displaying the image provided by taking the image of the cut face of the embedding block illuminated by the collimated on axis illuminating system at the display portion, the operator can grasp the current state of cutting the embedding block and acceptability of proceeding to the regular cutting step can easily be determined. Further, even when it is determined that proceeding to the regular cutting step is unacceptable, by inclining the support base or adjusting a cut depth of the cut blade, an operational efficiency until proceeding to the regular cutting step is made to be acceptable can be increased.

Further, according to the sectioning method of the invention, there is provided the sectioning method, wherein the illuminating step comprises a down emitting illuminating step of illuminating along an optical axis orthogonal to the one imaginary plane, and a diverging illuminating step of illuminating by diverged light, and the down emitting illuminating step and the diverging illuminating step are carried out alternately.

According to the invention, the diverging illuminating system and the collimated on axis illuminating system are switched by the illumination switching portion, the images provided by illuminated light of the respectives can be displayed simultaneously or either one of the images can alternately be displayed and the section face can further easily be specified.

According to the invention, a direction of the cut face relative to the cut blade can easily be changed while observing the cur face of the embedding block, and an efficiency of the rough cutting operation can be increased by specifying the section face by an inconsiderable burden.

### BRIEF DESCRIPTION OF THE DRAWINGS

FIG. 1 is a functional block diagram showing an instrument for fabricating a prepared slide of a tissue section according to a first embodiment of the invention;

FIG. 2 is a flowchart showing a sectioning method according to the first embodiment of the invention; and

FIG. 3 is a functional block diagram showing an instrument for fabricating a prepared slide of a tissue section according to a second embodiment of the invention.

### DETAILED DESCRIPTION OF THE PREFERRED EMBODIMENTS

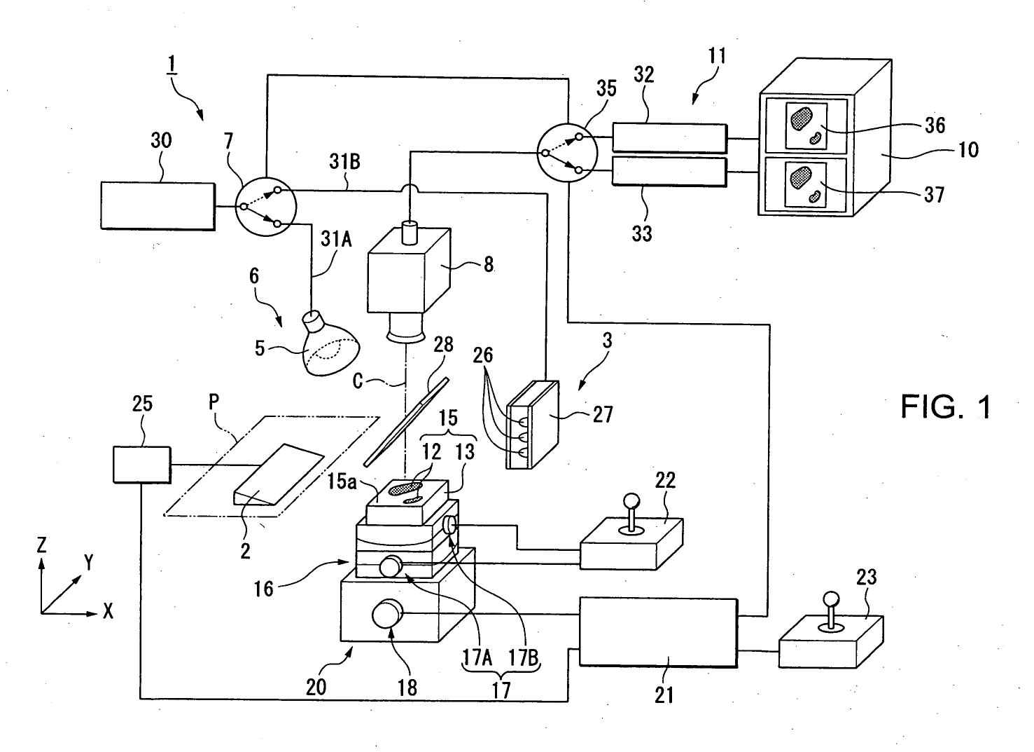

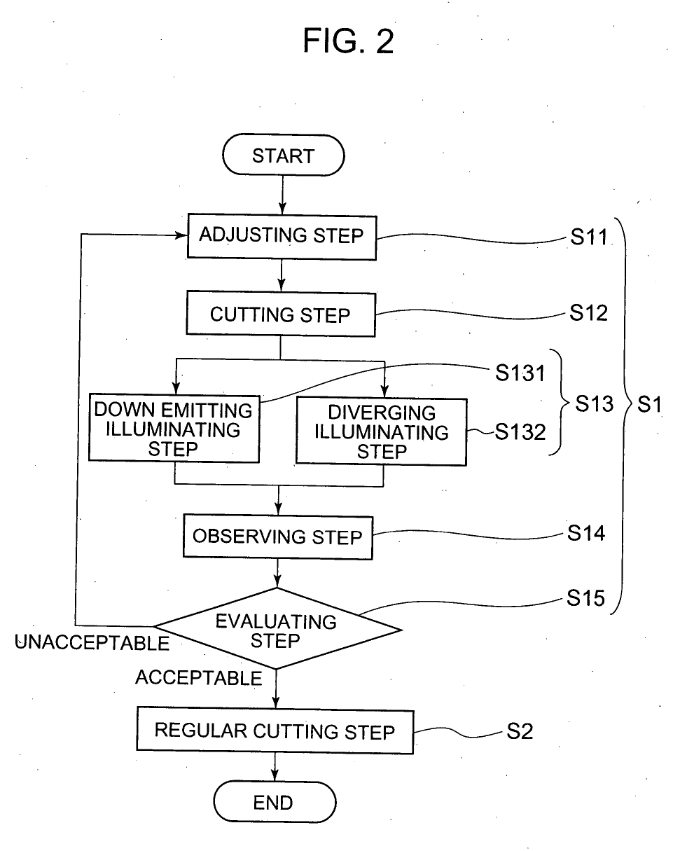

A first embodiment according to the invention will be explained in reference to FIG. 1 and FIG. 2.

As shown by FIG. 1, the instrument 1 for fabricating a prepared slide of a tissue section according to the embodiment includes a cut blade 2 moved along one imaginary plane P, a collimated on axis illuminating system 3 having an optical axis C in parallel with Z axis orthogonal to one imaginary plane P, a diverging illuminating system 6 having a light source 5 for illuminating diverged light, an illumination switching portion 7 for bringing either one of the diverging illuminating system 6 and the collimated on axis illuminating system 3 into a drive state, an observing system 11 having an image taking portion 8 arranged with an image taking element, not illustrated, having an image taking axis C the same as the optical axis C and a display portion 10 for displaying an image based on an image taking data acquired by the image taking portion 8, a base portion 20 having a support base (support portion) 16 mounted with an embedding block 15 in which a sample 12 is embedded in paraffin (embedding medium) 13, a pivoting mechanism 17 for pivoting the support base 16 around respective axes of X, Y axes orthogonal to each other on one imaginary plane P, and a straight advancing mechanism 18 for moving the support base 16 in a direction of Z axis constituting a direction orthogonal to one imaginary plane P and arranged on the optical axis C, a control portion 21, and a joystick (pivoting operating portion) 22 for operating the pivoting mechanism 17 and an input switch 23 for inputting a cut amount to the straight advancing mechanism 18, which are provided at positions of being remote from the support base 16.

The cut blade 2 is connected with a moving mechanism 25 for moving the cut blade 2 in a direction of X axis in the drawing along one imaginary plane P. Further, the moving mechanism may move the cut blade 2 along a curved line.

The collimated on axis illuminating system 3 includes a face light source 27 arranged with a plurality of LEDs 26 in a face-like shape, an optical system, not illustrated, for converting light illuminated from the face light source 27 into parallel light, and a half mirror 28 for reflecting parallel light to a side of the base portion 20 along the optical axis C direction and transmitting light reflected from the embedding block 15. Further, the light source may be a light source for converting light from a point light source into parallel light by passing the light through a pin hole and a collimating lens.

An input side of the illumination switching portion 7 is connected with a power source 30 for illumination for supplying power to the light source 5 and the face light source 27, and an output side thereof is connected with the light source 5 and the face light source 27 by way of electric wirings 31A, 31B.

The observing system 11 further includes a first image storing portion 32 for storing image data provided under illumination by the diverging illuminating system 6, a second image storing portion 33 for storing image data provided under illumination by the collimated on axis illuminating system 3, and an image switching portion 35 for outputting image data inputted from the image taking portion 8 to either one of the first image storing portion 32 or the second image storing portion 33. The image switching portion 35 is operated in synchronism with the illumination switching portion 7.

The display portion 10 can call and display image data stored to the first image storing portion 32 as an image 36 provided under illumination by the diverging illuminating system 6 and image data stored to the second image storing portion 33 as an image 37 provided under illumination by the collimated on axis illuminating system 3 time-sequentially from the respective storing portions 32, 33. At this occasion, the images are displayed by a desired magnification in cooperation with the observing system 11. Further, the both images may be overlapped to display, further, either one of the images may alternately be displayed.

The pivoting mechanism 17 further includes a Y axis pivoting mechanism 17A for pivoting the support base 16 around Y axis and an X axis pivoting mechanism 17B for pivoting the support base 16 around X axis by operating the joy stick 22. The straight advancing mechanism 18 moves up and down the pivoting mechanism 17 and the support base 16 in a direction of Z axis based on a set value of a cut amount inputted from the input switch 23 and based on an instruction from the control portion 21.

The control portion 21 is respectively connected to the moving mechanism 25, the straight advancing mechanism 18, the image switching portion 35. Further, with regard to the moving mechanism 25, a moving speed (cutting speed) of the cut blade 2 relative to the base portion 20 is controlled, and an amount of feeding the cut blade 2 is controlled. Further, with regard to the image switching portion 35, either one of the diverging illuminating system 6 and the collimated on axis illuminating system 3 is controlled at a predetermined timing.

Next, operation of the sectioning method and instrument 1 for fabricating a prepared slide of a tissue section according to the embodiment will be explained.

As shown by FIG. 2, the method is provided with a rough cutting step (S1) of the embedding block 15, and a regular cutting step (S2) for providing a section, not illustrated from the embedding block 15 after rough cutting.

The rough cutting step (S1) is further provided with an adjusting step (S11) of determining a position of a surface of the embedding block 15 relative to the cut blade 2, a cutting step (S12) for cutting the surface of the embedding block 15 by moving the cut blade 2 along one imaginary plane P, an illuminating step (S13) of illuminating a cut face 15a of the embedding block 15 from a direction orthogonal to one imaginary plane P, an observing step (S14) of taking an image of the cut face 15a of the illuminated embedding block 15 to display the image, and an evaluating step (S15) of determining whether the operation proceeds to the regular cutting step (S2) from the image. Further, when the operation does not proceed to the regular cutting step (S2) at the evaluating step (S15), the operation returns to the adjusting step (S11). A detailed explanation will be given of the respective steps as follows.

First, the embedding block 15 is mounted on the support base 16 manually or automatically. Further, the adjusting step (S11) is carried out. That is, by the input switch 23, for example, an amount of cutting the embedding block 15 in Z direction is automatically set within a range of 10 μm through several tens μm. At this occasion, an operator inclines the support base 16 relative to the cut blade 2 by a predetermined angle by driving the pivoting mechanism 17 by the joy stick 22 as necessary. In this way, the base portion 20 is positioned to a predetermined position relative to the cut blade 2.

At the cutting step (S12), the cut blade 2 is moved in X axis direction by driving the moving mechanism 25 based on the instruction of the control portion 21. At that occasion, one imaginary plane P and a topmost face of the embedding block 15 differ from each other, and therefore, the cut blade 2 is brought into contact with the embedding block 15 and an upper end of the embedding block 15 is cut by a predetermined thickness.

The illuminating step (S13) further includes a down emitting illuminating step (S131) of illuminating along the optical axis C by driving the collimated on axis illuminating system 3, and a diverging illuminating step (S132) of illuminating by diverged light by driving the diverging illuminating system 6. Either one of the down emitting illuminating step (S131) and the diverging illuminating step (S132) is carried out by alternately driving the collimated on axis illuminating system 3 or the diverging illuminating system 6 by driving the power source 30 for illumination and the illumination switching portion 7.

Here, at the down emitting illuminating step (S131), light is irradiated from the face light source 27 by supplying a power source from the power source 30 for illumination to the face light source 27. Illuminated light is reflected by the half mirror 28 and is reflected by the cut face 15a of the embedding block 15. At this occasion, whereas mirror face reflection is constituted at a portion of the paraffin 13, since light is scattered at a portion of the sample 12, when the sample 12 is exposed to the cut face 15a, a difference is brought about in an intensity of reflected light.

At the diverging illuminating step (S132), diverged light is irradiated from the light source 5 by supplying a light source from the power source 30 for illumination to the light source 5. Light emitted from the light source 5 reaches the cut face 15a of the embedding block 15 as it is. At that occasion, light is reflected not only from the cut face 15a but also from the sample 12 at inside thereof.

At the observing step (S14), light reflected from the embedding block 15 is inputted to the image taking portion 8. At this occasion, the image switching portion 35 is synchronized with the illumination switching portion 7. Hence, data of an image taken when illuminated light by the collimated on axis illuminating system 3 is irradiated is stored to the first image storing portion 32 as image data showing the cut face 15a. On the other hand, data of an image taken when illuminated light by the diverging illuminating system 6 is irradiated is stored to the second image storing portion 33 as image data showing the cut face 15a and inside of the embedding block 15. Further, by outputting the respective image data from the first image storing portion 32 and the second image storing portion 33, the image data are displayed as the images 36, 37 showing the same embedding block 15.

At the evaluating step (S15), the operator observes the images 36, 37 displayed at the display portion 10 and determines whether the cut face 15a of the embedding block 15 is brought into a state of capable of forming the section at the regular cutting step (S2). Here, when the cut face 15a is determined as ‘acceptable’, the operation proceeds to the regular cutting step (S2). Further, the base portion 20 is positioned to constitute a predetermined thickness (for example, 5 μm), the embedding block 15 is cut by a cut blade different from the cut blade 2 to finish operation.

On the other hand, when proceeding to the regular cutting step (S2) is determined to be ‘unacceptable’, in order to cut the embedding block 15 again, the operation returns to the adjusting step (S11) and the above-described operation is repeatedly carried out until determined to be ‘acceptable’ at the evaluating step (S15).

According to the instrument 1 for fabricating a prepared slide of a tissue section and the sectioning method, the image provided by taking the image of the cut face 15a of the embedding block 15 illuminated by the collimated on axis illuminating system 3 can be displayed by the display portion 10. At that occasion, since illumination is down emitting illumination, based on a difference between reflectances of the sample 12 and the paraffin 13 at inside of the embedding block 15, the operator can easily grasp a current state of cutting the embedding block 15. Further, by the diverging illuminating system 6, not only the cut face 15a of the sample 12 but also a state in a depth direction can be observed.

At this occasion, by storing image data provided by the respective illuminating systems 3, 6 to the first image storing portion 32 and the second image storing portion 33 and respectively calling the image data, the image provided by either one of the diverging illuminating system 6 or the collimated on axis illuminating system 3 and the image provided by other thereof can be displayed at the display portion 10 simultaneously or respectively alternately, and the cut face 15a can easily be specified.

Further, when it is necessary to incline and cut the embedding block 15 relative to one imaginary plane P as a result of observation, the embedding block 15 can be cut by a desired inclined face by pivoting the support base 16 by the pivoting mechanism 17. That is, a direction of the cut face 15a relative to the cut blade 2 can easily be changed while observing the cut face 15a of the embedding block 15, and an efficiency of the rough cutting operation can be increased by specifying the section face with inconsiderable burden regardless of the skill of the operator by semiautomatic formation.

Further, by arranging the joy stick 22 at the hand side of the operator, the operator can operate to incline the support base 16 relative to the cut blade 2 at hand while observing the image of the display portion 10 and a burden for adjustment can be alleviated.

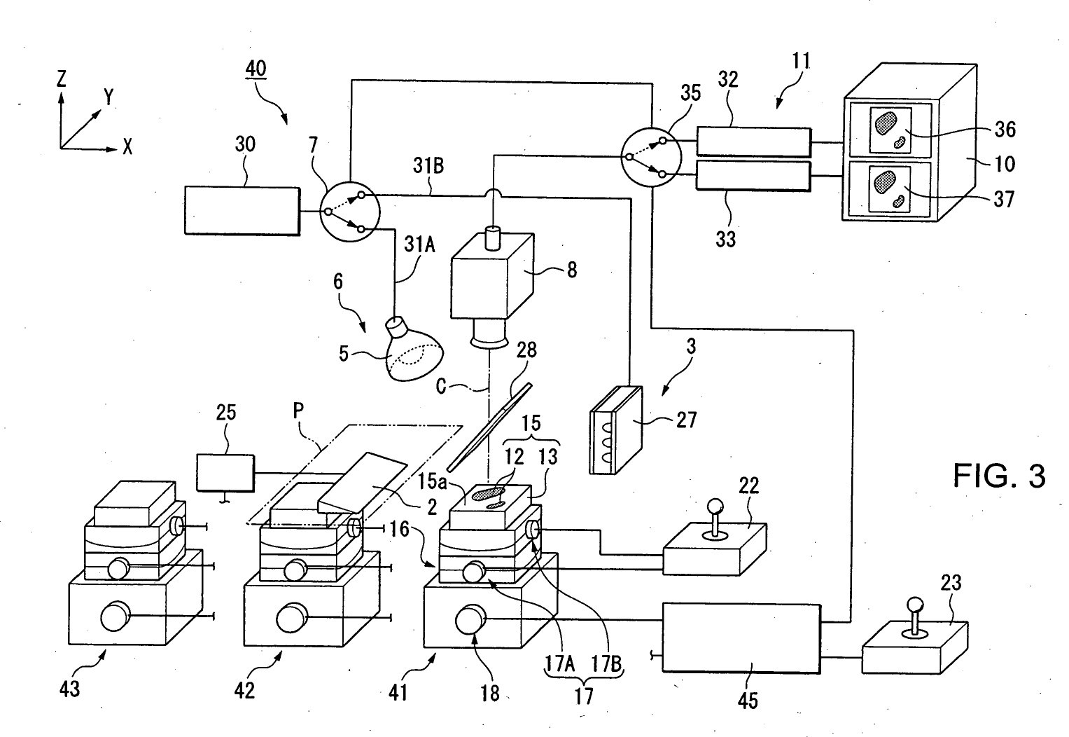

Next, a second embodiment will be explained in reference to FIG. 3.

Further, constituent elements similar to those of the above-described first embodiment are attached with the same notations and an explanation thereof will be omitted.

A point of the second embodiment which differs from the first embodiment resides in that an instrument 40 for fabricating a prepared slide of a tissue section according to the embodiment is arranged with three base portions 41, 42, 43 having the same constitution to align movably in a direction of moving the cut blade 2.

The respective base portions 41, 42, 43 are arranged on a guide rail, not illustrated, extended in the direction of moving the cut blade 2 in one row and are moved simultaneously by a predetermined speed in a direction reverse to the direction of moving the cut blade 2. The joy stick 22 is respectively connected to the pivoting mechanisms 17 of the respective base portions 41, 42, 43 and the input switch 23 is respectively connected to the straight advancing mechanisms 18. A control portion 45 also controls to move the respective base portions 41, 42, 43.

Next, an explanation will be given of operation of both of the sectioning method and the instrument 40 for fabricating a prepared slide of a tissue section according to the embodiment.

The sectioning method according to the embodiment basically achieves a sectioning method and operation similar to those of the first embodiment.

First, the embedding blocks 15 are mounted on the respective support bases 16 manually or automatically. Further, the adjusting step (S11) is carried out. That is, by the input switch 23, for example, an amount of cutting the embedding block 15 in Z direction is automatically set within a range of 10 μm through several tens μm. At this occasion, the operator inclines the respective support bases 16 by a predetermined angle relative to the cut blade 2 by driving the pivoting mechanisms 17 by the joy stick 22. In this way, the respective base portions 41, 42, 43 are positioned to predetermined positions relative to the cut blade 2.

At the cutting step (S12), the cut blade 2 is moved in X axis direction by driving the moving mechanism 25 based on the instruction of the control portion 45. At this occasion, the respective base portions 41, 42, 43 are moved in a direction inverse to the direction of moving the cut blade 2 by a predetermined speed in synchronism with the moving mechanism 25. In this way, upper ends of the embedding blocks 15 on the respective support bases 16 are successively cut by a predetermined thickness.

At the illuminating step (S13), the respective base portions 41, 42, 43 are successively moved onto the optical axis C based on the instruction of the control portion 45. Further, the respective base portions 41, 42, 43 are stopped at each time of being coincident with the optical axis C, and the cut faces 15a of the embedding blocks 15 are illuminated by carrying out either one of the down emitting illuminating step (S131) or the diverging illuminating step (S132) by driving the power source 30 for illumination and the illumination switching portion 7. At this occasion, the observing step (S14) is carried out and light reflected from the embedding blocks 15 is inputted to the image taking portion 8. Further, the provided image data are respectively stored to the first image storing portion 32 and the second image storing portion 33, further, the image data are outputted to display as the images 36, 37 respectively showing the same embedding blocks 15. At the evaluating step (S15), the acceptability is evaluated similar to the first embodiment for the respective embedding blocks 15.

According to the instrument 40 for fabricating a prepared slide of a tissue section and the sectioning method, operation and effect similar to those of the first embodiment can be achieved, in addition thereto, the plurality of embedding blocks 15 can continuously be cut roughly and an operational efficiency can considerably be increased.

Further, the technical range of the invention is not limited to the above-described embodiments but can variously be changed within the range not deviated from the gist of the invention.

For example, the cut blade 2 may not be moved on a straight line but may be moved on a circular arc. At this occasion, in the case of the second embodiment, the respective base portions 41, 42, 43 may be arranged along a locus of moving the cut blade 2 and may be made to be movable thereon. Further, a number of pieces of the base portions at this occasion is not limited to three but may only be plural. Further, the respective base portions 41, 42, 43 may not simultaneously be cut roughly but may be cut roughly one by one.

What is claimed is:

1. An instrument for fabricating a prepared slide of a tissue section comprising:
a cut blade moved along one imaginary plane;
a collimated on axis illuminating system having an optical axis orthogonal to the one imaginary plane;
an observing system including an image taking portion having an image taking axis substantially the same as the optical axis and a display portion for displaying an image based on an image taking data acquired by the image taking portion; and
a base portion including a support portion mounted with an embedding block in which a sample is embedded in an embedding medium, a pivoting mechanism for pivoting the support portion around respective axes of two axes orthogonal to each other on the one imaginary plane, and a straight advancing mechanism for moving the support portion in a direction orthogonal to the one imaginary plane and arranged on the optical axis.

2. The instrument for fabricating a prepared slide of a tissue section according to claim 1, wherein a pivoting operating portion for operating the pivoting mechanism is provided at a position of being remote from the support portion.

3. The instrument for fabricating a prepared slide of a tissue section according to claim 1, further comprising:
a diverging illuminating system having a light source for irradiating diverged light; and
an illumination switching portion for bringing either one of the diverging illuminating system and the collimated on axis illuminating system into a drive state;
wherein the observing system comprises a first image storing portion for storing an image data provided under illumination by the diverging illuminating system, and a second image storing portion for storing an image data provided under illumination by the collimated on axis illuminating system.

4. The instrument for fabricating a prepared slide of a tissue section according to claims 1, wherein a plurality of the base portions are arranged to align movably to be opposedly to a direction of moving the cut blade.

5. A sectioning method which is a sectioning method comprising a rough cutting step of roughly cutting an embedding block in which a living body sample is embedded in an embedding medium by a cut blade, and a regular cutting step for providing a section from the embedding block after having been cut roughly;
wherein the rough cutting step comprises:
an adjusting step of determining a position of a surface of the embedding block relative to the cut blade;
a cutting step of cutting the surface of the embedding block by moving the cut blade along one imaginary plane;
an illuminating step of illuminating a cut face of the embedding block from a direction orthogonal to the one imaginary plane;
an observing step of taking an image of the cut face of the illuminated embedding block and displaying the image; and
an evaluating step of determining whether the rough cutting step is to proceed to the regular cutting step from the image;
wherein the rough cutting step returns to the adjusting step when proceeding to the regular cutting step is unacceptable at the evaluating step.

6. The sectioning step according to claim 5, wherein the illuminating step comprises a down emitting illuminating step of illuminating along an optical axis orthogonal to the one imaginary plane, and a diverging illuminating step of illuminating by diverged light; and
wherein the down emitting illuminating step and the diverging illuminating step are carried out alternately.
